(19) United States
(12) Patent Application Publication
(10) Pub. No.: US 2008/0147291 A1
(43) Pub. Date: Jun. 19, 2008

(54) Method For Detecting At Least One Valve Lift Position In An Internal Combustion Engine Having Variable Valve Control

(75) Inventor: Niraimathi Appavu Mariappan, Stuttgart (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 11/630,719

(22) PCT Filed: Apr. 20, 2005
(86) PCT No.: PCT/EP2005/051737

§ 371 Date: Dec. 21, 2006

(30) Foreign Application Priority Data
Jun. 23, 2004 (DE) 10 2004 030 306.1

(51) Int. Cl. F02D 45/00

(52) U.S. Cl. 701/102; 702/50

(57) ABSTRACT

Procedure for the recording of a valve lift of an internal combustion engine with valves, which are operated variably through application of an hydraulic pressure, whereby the valve lift is determined on the basis of a change of the hydraulic pressure.

### STATE OF THE ART

The invention concerns a procedure to ascertain at least one valve lift position of an internal combustion engine with valves, which are operated variably by way of the application of an hydraulic force according to the class of the independent claim.

The subjects of the invention at hand are a device for operation of a valve control, especially an electronic control unit of an internal combustion engine as well as a computer program product for employment of the procedure according to the invention on a computer or in a control unit.

In conventional internal combustion engines the gas exchange occurs by way of spring-loaded valves, which are opened by a camshaft. The time based progression of the valve lift, that is the beginning and duration of the valve opening, and respectively the position of the cam follower (lifter) are determined by the shaping of the camshaft but are not variable. Concepts for the variable activation of charge-cycle valves are increasingly being employed to improve the degree of efficiency of internal combustion engines and also to reduce their exhaust emissions. For example, the intake and exhaust times of charge-cycle valves can be varied by changing the phasing of the camshaft. A flexible operation of the internal combustion engine is possible if the charge-cycle valves are not activated by means of a camshaft but are directly activated.

For example, from the patent WO 91/03384 a complete variable valve control is known, whereby the charge-cycle valves are electrically or hydraulically operated. The valve lift is in this instance ascertained by way of a valve lift sensor.

The exact knowledge of the valve lift is necessary in order to assure an efficient operation of the internal combustion engine and also among other things to prevent misfires or collisions of the charge-cycle valves with the pistons.

The German patent DE 100 64 650 describes a procedure to control the charge-cycle valves of an internal combustion engine with a variable valve lift. The control of the valve results as a function of an analysis of a pressure in the combustion chamber of the motor, whereby the analysis of the pressure in the combustion chamber essentially serves to calibrate an existing valve lift sensor.

The procedure according to the invention with the characteristics of the independent claim has in contrast to the aforementioned one the advantage, that at least one valve lift position is determined on the basis of a change of an hydraulic pressure resting on the valve. By way of this action a valve lift position can also be determined in an advantageous manner without the presence of a valve lift sensor.

By way of the measures listed in the sub-claims, advantageous modifications and improvements of the procedure specified in the independent claim are possible.

It is particularly advantageous to ascertain a valve opening time and a valve closing time starting from a moment (point in time), whereby the pressure in the hydraulic system is beginning to drop off. This has the advantage, that with very little effort in measuring and also without the presence of a valve lift sensor, relevant parameters for the operation of a variable valve control can be ascertained. In addition with the presence of a valve lift sensor, the valve lift sensor signals can be checked, whereby the operational reliability is increased.

According to an additional advantageous embodiment, valve opening and closing time allow themselves to be ascertained at a moment (point in time), where the pressure falls below a threshold value. This has the advantage, that with the appropriate choice of a threshold value, pressure fluctuations that can potentially arise have no influence on the ascertainment of the relevant opening and closing times.

According to an additional embodiment, it is advantageous to determine a time in which the valve opens, respectively closes, on the basis of a maximum, respectively extreme value, of a drop in the hydraulic pressure. This has the advantage, that extreme values in the pressure flow (curve) can be easily identified, and they tend to differentiate themselves as a rule clearly from other events of pressure.

According to an additional advantageous embodiment, a time based progression of a valve lift based upon at least one valve lift position and/or upon the time based progression of the hydraulic pressure is determined. This has the advantage, that not only individual positions but also the valve lift over the time can be recorded; and an efficient operation of the valves can be explicitly checked during the operation of the internal combustion engine.

According to an additional advantageous embodiment, provision is made to check during a specific time interval if a relevant pressure change has emerged, whereby an error response is initiated if the change of pressure is absent. By the specification of a time interval specific to the valves and cylinders, in which a relevant change of pressure is supposed to emerge, it will be possible in an advantageous manner to check the correct function of, for example, a charge-cycle valve and to initiate an error response when disturbances occur.

According to an additional advantageous embodiment, provision is made for a device for the operation of a valve control, especially the electronic control unit of an internal combustion engine, which is programmed for the application of a procedure to record a valve lift. Thus, it is possible to undertake centrally in one unit the collection, processing, analysis and output of signals, whereby the complexity of the components and the circuitry as well as the operational susceptibility to disturbances are reduced in an advantageous manner.

According to an additional advantageous embodiment, provision is made for a computer program product with a program code, that is stored on a machine-readable carrier, so that a procedure to ascertain a valve lift is employed, as soon as the program is executed on the computer or in the control unit.

### DRAWINGS

Additional characteristics, application possibilities and advantages of the invention result from the following description of embodiment examples of the invention, which are depicted in the drawings. In so doing, all described or depicted characteristics by themselves or in any desired combination form the subject matter of the invention and are independent from their summarization in the patent claims or the retroactive relationship of the claims and are as well independent of their formulation, respectively depiction, in the description, respectively in the drawings.

The following are depicted:

FIG. 1 shows schematically an electro-hydraulically operated valve.

FIG. 2 shows schematically the time based progression of the switching states of the activated solenoid-controlled valves and corresponding parameters.

FIG. 3 shows a flow diagram for the recognition of errors of an hydraulic valve.

FIG. 4 shows schematically a logic circuit for error recognition.

### DESCRIPTION

The invention is based on the idea, that the hydraulic pressure changes in an electro-hydraulic valve-servo (control) system by the switching of servo (control) valves. When opening or closing an electro-hydraulic valve, for example, a charge-cycle valve, the servo (control) valves, for example solenoid-controlled values, are switched in a certain sequence, so that the hydraulic pressure in the system changes in a characteristic manner. As the characteristic changes in pressure at every opening and closing of the electro-hydraulic valve repeat themselves in a reproducible fashion, the knowledge of the pressure flow (pressure curve) in the hydraulic system makes it possible to draw a conclusion about additional parameters, for example, about a valve lift and/or a valve lift position.

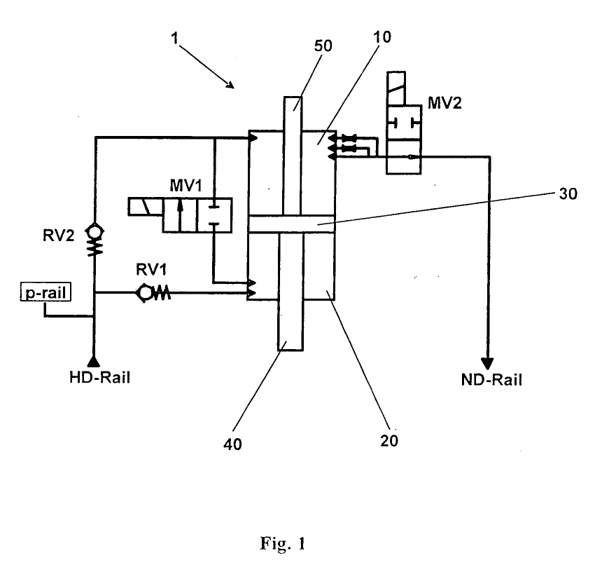

FIG. 1 shows schematically a valve which is operated electro-hydraulically, for example, a charge-cycle valve of an internal combustion engine. A relocateable gate 30 divides the pressure area of the valve 1 into an upper chamber 10 and a lower chamber 20. The gate 30 is connected with a guide lifter 50 in the direction of the upper chamber 10 and with a valve lifter 40 in the direction of the lower chamber 20. By way of a first check valve RV1, the lower chamber 20 is connected with the high pressure side of the hydraulic system, respectively high pressure collector line (rail) HD-Rail. The first check valve RV1 prevents a back flow from the lower chamber 20 back into the high pressure rail HD-Rail. The lower chamber 20 is connected with the upper chamber 10 by way of a solenoid-controlled valve MV1, when it is closed and not supplied with current. If the solenoid-controlled valve MV1 is supplied with current and consequently open, both chamber 10, 20 are connected with a second check valve RV2, which releases in the direction of the high pressure rail. The upper chamber 10 is furthermore connected with a low pressure rail by way of a second solenoid-controlled valve MV2, when it is open and not supplied with current. The pressure p_rail in the high pressure rail is registered via a pressure sensor.

In regard to an electro-hydraulic valve, a valve is thus to be understood, which is moved by application of an hydraulic pressure, whereby the hydraulic pressure corresponding to the desired valve movement is controlled, respectively switched, by means of an electrically operated servo (control) valve.

If the electro-hydraulic valve is, for example, embodied as a charge-cycle valve, a valve plate is placed on the one end of the valve lifter, which fits in a valve seat of the combustion chamber when the charge-cycle valve is closed. When the charge-cycle valve opens, the lifter 40 and the valve plate extend into the combustion area.

Without activation of, respectively current supply to, the solenoid-controlled valves, the first solenoid-controlled valve MV1 is closed and the second solenoid-controlled valve MV2 is open. The hydraulic pressure in the lower chamber 20 is consequently larger than in the upper chamber 10. Due to this pressure difference, the gate 30 moves in the direction of the upper chamber 10 until the hydraulic valve reaches an end position and is closed.

If the solenoid-controlled valves MV1, 2 are supplied with current, the first solenoid-controlled valve MV1 is open and the second solenoid-controlled valve MV2 is closed. The hydraulic pressure in the upper as well as lower chamber is consequently essentially the same. The surface of the gate 30 is, however, larger in the area of the upper chamber than in the lower chamber, so that the force acting on the gate 30 by means of the hydraulic pressure moves the gate 30 in the direction of the lower chamber 20 and the hydraulic valve 1 opens.

Of course the invention is not limited to the example of embodiment depicted, but may likewise be applied to other hydraulic arrangements using a switch. Especially the hydraulic switching or the position of the pressure sensor can be varied. Furthermore, it is conceivable to make provision for other adjustment elements in place of the solenoid-controlled valves.

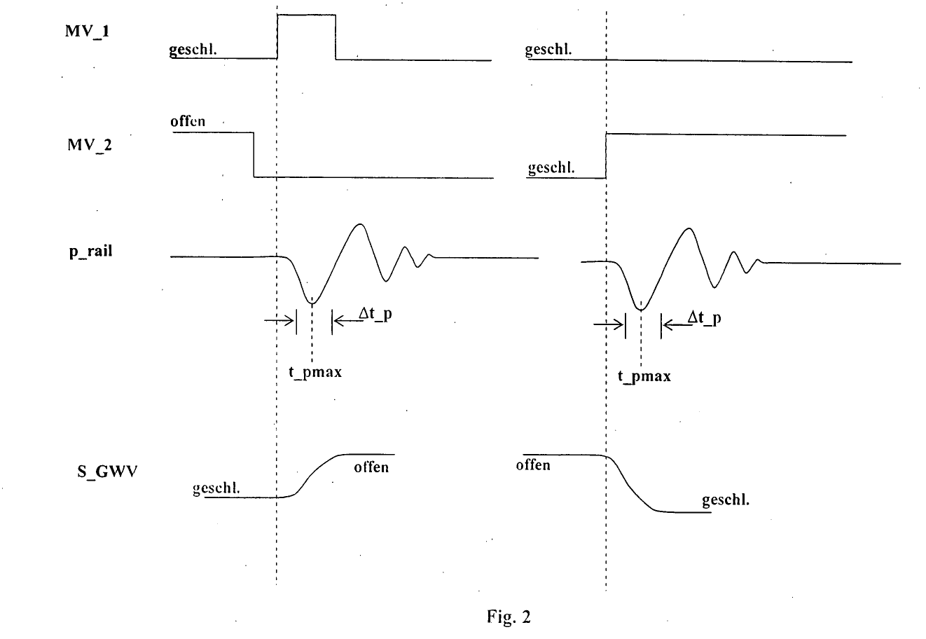

FIG. 2 shows schematically the time based progression of the switching states of the activated solenoid-controlled valves MV1, 2 and the time based progression of corresponding parameters like pressure flow (curve) p_rail in the high pressure rail and the valve lift S_GSW of the hydraulic valve, whereby the diagram on the left depicts the processes involved in opening the electro-hydraulic valve and the diagram on the right depicts the processes involved in closing the same.

As already described in regard to FIG. 1, the first solenoid-controlled valve MV1 is closed without current being supplied and the second solenoid-controlled valve MV2 is open without current being supplied. The pressure in the high pressure rail p_rail is essentially constant and the electro-hydraulic valve 1, respectively charge-cycle valve, is closed. The electro-hydraulic valve is opened, in that the second solenoid-controlled valve MV2 is first of all closed and subsequently the first solenoid-controlled valve MV1 is opened. After the electro-hydraulic valve has reached its end position—completely open, the first solenoid-controlled valve MV1 is closed.

The closing of the second solenoid-controlled valve MV2 does not cause any significant pressure fluctuations in the high pressure rail. Due to the initial conditions, the hydraulic pressure in the upper chamber 10 is less than in the lower chamber 20, so that hydraulic fluid from the lower chamber 20 comes into the upper chamber 10 when the solenoid-controlled valve MV1 is opening. The pressure p_rail in the high pressure rail sinks for a short time as a result of the pressure equalization between both chambers 10, 20. The drop in pressure reaches a maximum value at a moment (point in time) t_pmax. This moment t_pmax typically lies in a time interval [t1, t2] that is known for a respective cylinder Z_i (i= . . . n; n=cumulative number cylinders) and the respectively switched solenoid-controlled valve MV1, 2.

The time based progression of the drop in pressure, respectively relevant pressure changes, and also particularly the moment (point in time) t_pmax at which the pressure has maximally fallen, depend in a given system essentially upon the operating state of the electro-hydraulic valve. Influential parameters of consequence are, for example, the geometry and length of the hydraulic lines, the hydraulic pressure and the temperature of the hydraulic fluid. Additional parameters which also come under consideration are the temperature and the number of r.p.m. of the internal combustion engine, the speed of the lifter movement, pressure relationships in the combustion engine and if need be additional parameters.

The time based pressure flow (curve) p_rail in the high pressure rail can now be experimentally or through the construction of models brought into union with the valve lift, respectively the adjustment travel S_GWV of the electro-hydraulic valve, respectively the charge-cycle valve. Thus, it is possible to ascertain an actual existing valve lift and/or particularly a valve opening time t_o at known operating conditions from the pressure flow (curve) in the high pressure rail and/or the maximum drop in pressure and/or additional relevant pressure changes. In regard to relevant pressure changes, essentially all pressure changes or events are included, in which a conclusion can be drawn on the valve lift or the valve lift position. For example, an initial drop in pressure, pressure coming below the threshold value, pressure extreme values, minimum and maximum values, saddle points and others come into question when considering what a relevant pressure change is. The relevance of these points can be further increased, in that only relevant pressure changes are observed in a selected time interval.

Furthermore, the embodiment examples are explained on the basis of a maximum drop in pressure—as a possible example for a relevant pressure change. Of course, additional relevant pressure changes can be taken into consideration instead of or in addition to the maximum pressure drop.

In the lower left diagram of FIG. 2, the time based progression of the valve lift S_GWV of a charge-cycle valve being opened is depicted. Due, for example, to the friction of hydraulic resistances, an opening of the electro-hydraulic valve 1 is not to be immediately observed after the opening of the first solenoid-controlled valve but results with a systemically conditioned time delay.

It is, however, not absolutely necessary to take the entire time based pressure flow (curve) in the high pressure rail into consideration in order to determine the valve opening time t_o or the valve closing time t_s. On the contrary it is sufficient to ascertain the moment (point in time) of a characteristic, reproducible change in pressure. The maximum drop in pressure in the high pressure rail at a moment (point in time) t_pmax can serve as a possible characteristic pressure change, which typically is expected in a time interval [t1, t2] after the switching of a solenoid-controlled valve. If this moment (point in time) t_pmax is established, the valve opening time t_o and the closing time t_s can be ascertained by way of a corresponding model.

In the diagram on the right of FIG. 2, the closing process of the electro-hydraulic valve is depicted. For closing to take place, the first solenoid-controlled valve MV1 stays closed and the second solenoid-controlled valve MV2 opens. The upper chamber 10 is thus connected with the low pressure rail ND-Rail and lies under less of a pressure than the lower chamber 20. The gate 30 moves in the direction of the upper chamber 10, whereby the pressure p_rail in the high pressure rail drops for a short period of time.

Analogous to the valve opening, a maximum drop in pressure is to be observed in a time interval [t1, t2] at a moment (point in time) t_pmax. If the operating conditions of the electro-hydraulic valve and this moment (point in time) t_pmax are known, a valve closing time t_s can be ascertained from them. The time intervals [t1, t2], the moment (point in time) t_pmax as well as the closing time t_s and opening time t_o can be different for the closing process, respectively opening process of the valve. Especially the parameters for different valves and cylinders can vary.

The lower diagrams of FIG. 2 show a valve lift, respectively the adjustment travel S-GWV of an electro-hydraulic valve, respectively charge-cycle valve, during opening and closing. At a moment (point in time) of valve opening t_o and valve closing t_s, the moment (point in time) is identified, at which the valve sets itself in motion for the first time. The first motion typically occurs with a systemically conditioned time delay after the switching of the relevant servo valve MV1 or MV2. The possibility exists for a known system to ascertain the closing moment (point in time), respectively the opening moment (point in time), when the systemically conditioned time delay on the basis of the switching times of the servo valves MV1, MV2 is taken into consideration. We are, however, dealing with an expected opening time, respectively closing time, without an examination of the actual opening process, respectively closing process. It is more reliable to determine the opening time t_o, respectively closing time t_s, on the basis of a parameter that is only to be observed at an actual opening movement, respectively closing movement, of the valve, which has taken place. As described the times t_o, t_s can be obtained according to the invention, for example, from the analysis of the time based pressure flow (curve) and particularly from the moment (point in time) t_pmax of the maximum drop in pressure.

Furthermore, the moment (point in time) of the maximum drop in pressure can also be used for the purpose of checking the functioning capability of an electro-hydraulic valve, especially a charge-cycle valve. In FIG. 3 a flow diagram of a possible control procedure is depicted. It is assumed, thereby, that the pressure p_rail in the high pressure rail can be ascertained in regular, short time intervals. In one step 600 all moments (points in time) to be measured t_m, which fall in a relevant time interval [t1, t2] for a respective cylinder are recorded with their respective pressures p_rail. In the step 610 a maximum value p_max is ascertained from the pressures p_rail recorded from the time interval [t1, t2]. In the step 620 a check is made, if this maximal value p_max exceeds a threshold value S_p. If the threshold value S_p is exceeded, a release of the corresponding charge-cycle valve results. If the threshold value S_p is not exceeded, the corresponding charge-cycle valve is blocked and if need be the matching cylinder is turned off.

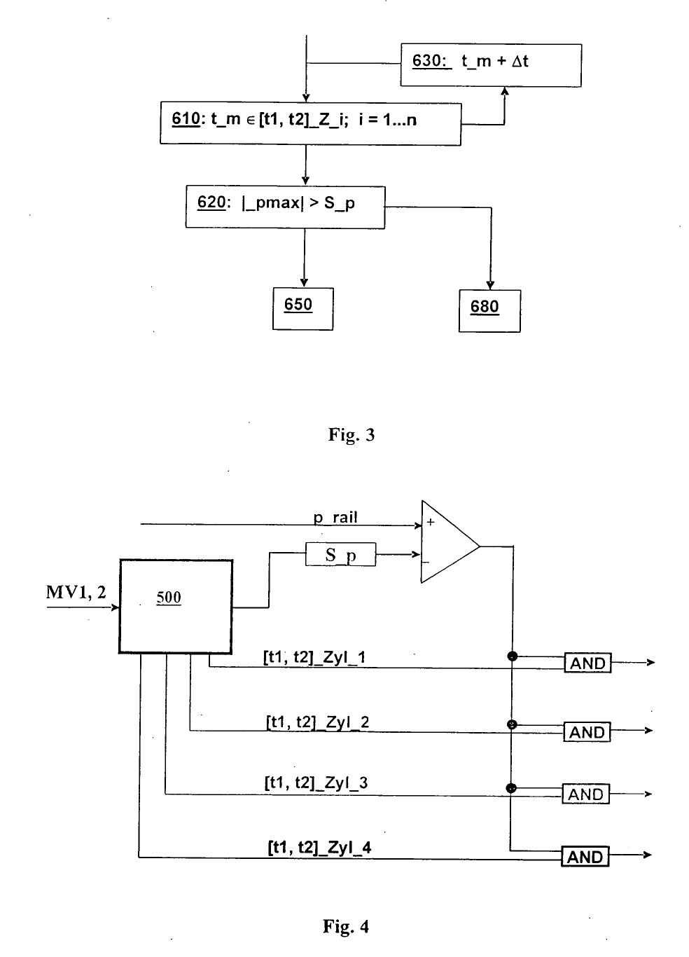

In FIG. 4 a possible logic circuit arrangement for the checking of a charge-cycle valve of a four cylinder internal combustion engine is depicted. The arrangement is comprised of a microprocessor 500, a comparator 400 and four AND operators with two inputs. Based upon positioning signals of the solenoid valves MV1, 2 and if need be those of additional operating parameters, the microprocessor 500 ascertains a pressure threshold value S_p, which forms an input parameter of the comparator 400, and furthermore during a specific time interval [t1, t2]_Z_{—}1, 2, 3, 4 sets specific to each cylinder a second input of an AND operator to the logical value TRUE. The comparator 400 compares the pressure p_rail in the high pressure rail with the pressure threshold S_p which the microprocessor provided; and then sets all first inputs of the AND operators to the logical value TRUE, if the pressure p_rail in the high pressure rail exceeds the threshold value S_p. As soon as TRUE-signals lie at both inputs of an AND operator, a logical value TRUE is transmitted and consequently signals an efficient functioning of a charge-cycle valve for this cylinder.

The logic outputs and AND operators can, for example, be monitored by a control unit, whereby when the logic values point to a malfunctioning of the valves, an error response is introduced. If, for example, the moment (point in time) t_pmax of the maximum drop in pressure lies outside of the acceptable time interval [t1, t2], a TRUE-signal for the time interval [t1, t2] lies in fact at the AND operator; however, the “t_pmax”-signal is not existent and is set to FALSE, so that the AND operator also emits a FALSE-signal.

According to a preferred embodiment example, the rail pressure p_rail in the high pressure rail is recorded continually or in certain time intervals. The recorded pressure values are preferably filtered in order to gate out perturbations. Instead of the pressure values the pressure changes, for example the time-based discharge of pressure flow (the time based deflection of the pressure curve), can also be taken into consideration. In the case of the opening, respectively closing of a charge-cycle valve, a time window, during which the relevant pressure signals are recorded, is opened. This time window occurs after the first solenoid-controlled valve MV1 is opened, respectively after the second solenoid-controlled valve MV2 is opened, by way of a microprocessor or a separate time monitor for the respective time interval [t1, t2]. The recorded pressure signals are analyzed and a moment (point in time) of opening, respectively a moment (point in time) of closing t_s of the monitored charge-cycle valve is determined. The calculated moments (points in time) are given further to an electronic control unit for additional processing.

In the case of a stuck charge-cycle valve, no corresponding drop in pressure is detected in the time interval [t1, t2] and the corresponding charge-cycle valve, respectively its matching cylinder, is shut down, in that the fuel injection and the ignition, for example, for this cylinder are no longer enabled. Further measures beyond these are conceivable for an emergency drive operation or reactivation of the charge-cycle valve.

The procedure according to the invention is already integrated in an advantageous way as hardware or also as software in an electronic control unit of the internal combustion engine.

The recording of the pressure signals typically occurs in a pulse frequency which is characteristic for the operation of the electronic control unit, respectively the internal combustion engine. For example, this is done on the basis of bus pulses or crankshaft angles or positions.

The pulse frequencies can easily be converted into another frame of reference. In the case of charge-cycle valves, the crankshaft angles are preferably chosen as the reference parameter. In this manner the opening and closing angles of the charge-cycle valves allow themselves to be determined from pressure changes in the hydraulic system.

As already mentioned, the pressure and especially the pressure changes in the hydraulic system are influenced by a multitude of parameters. Thus, during the opening of a charge-cycle valve, for example, a drop in pressure in the hydraulic system is not to be immediately observed at the beginning of the opening movement, but first with a specific time delay. The time delay is essentially contingent upon the length of the hydraulic path between the valve and the pressure measurement, whereby pressure and temperature of the hydraulic fluid additionally influence the delay time. With knowledge of these relationships the valve lift can be depicted as a function of pressure and temperature of the hydraulic fluid, and can, for example, be deposited as a function or characteristic index (table) in an electronic control unit. The depositing as a characteristic index is particularly suitable if calculation time in the electronic control unit is to be conserved or if the values, for example, are not to be ascertained by way of a modeling but empirically.

According to an additional embodiment example, it is conceivable, not to ascertain the pressure change or to ascertain it not only in the high pressure rail, but by using pressure measurements in the upper and/or lower chamber 10, 20 of the valve. In so doing, the length of the hydraulic paths can be shortened, whereby the time delay between the valve movement and the pressure change reduces itself and if need be is to be disregarded.

1. A method for recording at least one valve lift position in an internal combustion engine with valves, which are variably operated by application of hydraulic pressure, the method comprising determining the at least one valve lift position on the basis of a change in the hydraulic pressure.

2. A method according to claim 1, further comprising determining a moment at which the hydraulic pressure drops from at least a valve lift position, a valve opening time t_o or as a valve closing time t_s.

3. A method according to claim 1, further comprising determining at which the hydraulic pressure drops below a threshold value from at least a valve lift position, a valve opening time t_o or as a valve closing time t_s.

4. A method according to claim 1, further comprising determining a maximum drop in pressure, from at least a valve lift position, a valve opening time t_o and/or as a valve closing time t_s.

5. A method according to claim 1, further comprising determining a time based progression of a valve lift on the basis of at least one valve lift position.

6. A method according to claim 1 further comprising introducing an error response if no relevant change in pressure emerges during a specific time interval.

7. A device for the operation of a valve control that is programmed for recording at least one valve lift position in an internal combustion engine with valves, which are variably operated by application of hydraulic pressure.

8. A computer program product with a program code, which is stored on a machine-readable carrier for recording at least one valve lift position in an internal combustion engine with valves, which are variably operated by application of hydraulic pressure, the method comprising determining the at least one valve lift position on the basis of a change in the hydraulic pressure.
